(19) United States
(12) Patent Application Publication
(10) Pub. No.: US 2007/0130201 A1
(43) Pub. Date: Jun. 7, 2007

(54) System, method, and computer program product for synchronizing price information among various sources of price information

(75) Inventors: Richard M. Ratliff, Flower Mound, TX (US); Bejugum V. Rao, Flower Mound, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/293,956

(22) Filed: Dec. 5, 2005

(51) Int. Cl. G06F 7/00

(52) U.S. Cl. 707/104.1

(57) ABSTRACT

A system, method, and computer program product to synchronize price information among various sources of price information in response to the modification of a price of an item by one source. The price modification may occur in response to a request for price information for a particular item and an analysis of the price information to determine price-competitiveness. The modified price may be provided by the modifying source to other sources of price information for the particular item. Alternatively, the modified price may be provided by the modifying source to a controlling source of price information for the particular item, and then provided by the controlling source to other sources if approved at the controlling source.

### FIELD OF THE INVENTION

Embodiments of the invention relate generally to systems for providing price information for products and services, and more particularly, to systems, methods, and computer program products for synchronizing price information among various sources of price information.

### BACKGROUND OF THE INVENTION

Shopping has become one of the most common tasks performed using the Internet, and specifically the World Wide Web. Shopping online enables a potential customer to quickly and easily research and purchase many items, such as consumer electronics equipment (e.g., televisions and computers), books, music, and travel services/arrangements (e.g., hotel reservations and airline tickets). Even if the potential customer may not intend to purchase the items online, the Internet has made it very easy to compare prices for the same or similar items in order to find the least expensive source (online or offline) from which to purchase the item.

This ease with which a potential customer can compare prices for the same or similar items presents a challenge for suppliers of such goods or services because customers can readily see when a supplier's goods or services are more expensive than those of another supplier. This may be especially true when the goods or services are being sold via a sales channel that sells the same or similar goods or services provided by many different suppliers. Consider, for example, travel planning websites which sell similar travel services from many different suppliers (e.g., hotel reservations for many different hotels or airline tickets for many different airlines). A potential customer searching for a hotel reservation can easily see that a reservation for a particular hotel is more expensive than a reservation for another hotel. Many price-conscious customers will opt for the less expensive item, especially if other aspects of the item (e.g., same class of hotel) are the same or similar. Some suppliers of goods and services may offer a “lowest price guarantee,” in which the supplier may offer to match a lower price offered by another supplier. However, some customers may be unaware of such a guarantee, and even customers who know of such a guarantee may not take the time to contact the higher priced supplier to invoke the guarantee and will simply purchase the item from the lower priced supplier. Thus, displaying a higher price for an item relative to the same or similar item in response to a customer request will often cause the higher priced supplier to lose a sale, even if the supplier was willing to lower the price to be more price-competitive.

One method of reducing the likelihood of losing a sale because of an uncompetitive price is to analyze the price-competitiveness of the price of a particular item, relative to the price of the same or similar items, and modify the price if necessary prior to providing the price to a potential customer. Such a method is disclosed in U.S. patent application Ser. No. 09/961,419, entitled Availability Based on Value Creation Method and System, filed Sep. 25, 2001 and republished Apr. 24, 2004 as U.S. Patent Application Publication No. 2003/0078836, the contents of which are hereby incorporated in their entirety. While improving the price-competitiveness of the particular item for a particular customer request, such a method may cause a problem for those items that may be sold through a number of different sales channels. Consider again, for example, a travel planning website which sells hotel reservations from many different hotel chains. The travel planning website may modify the price of a reservation for a particular hotel in response to a customer request, such as by using the method disclosed in U.S. patent application Ser. No. 09/961,419. However, reservations for the particular hotel property within a hotel chain may also be sold through other sales channels, such as the hotel chain's own website, the hotel chain's own telephone reservation department (which may access the hotel chain's computerized reservation system (CRS) for price information), the reservation department at the particular hotel property (which may also access the hotel chain's CRS), other travel planning websites, and global distribution systems (GDSs). The various GDSs, such as Sabre, Amadeus, Galileo, and Worldspan, act as middlemen to sell travel components, such as airline tickets and hotel reservations, through various customer channels. As such, it may be possible that one seller may modify the price of a room reservation for a particular hotel while other sales channels (possibly even the hotel chain itself) do not. Customers may discover such mismatched pricing and thus may feel it is necessary to check pricing from several different sales channels in order to prevent paying a higher price than necessary, which may cause customer dissatisfaction.

### BRIEF SUMMARY OF THE INVENTION

A system, method, and computer program product are therefore provided that synchronize price information among various sources of price information in response to the modification of a price of an item by one source. The price modification may occur in response to a request for price information for a particular item and an analysis of the price information to determine price-competitiveness. The modified price may be provided by the modifying source to other sources of price information for the particular item. Alternatively, the modified price may be provided by the modifying source to a controlling source of price information for the particular item, and then provided by the controlling source to other sources if approved at the controlling source.

In this regard, a system for synchronizing price information comprises a computing device capable of receiving a request for price information associated with at least one item. The computing device is further capable of obtaining database results from a first database responsive to the request, with the database results comprising a plurality of entries each defining at least a price. The computing device is further capable of modifying at least one entry in the database results by changing the price to a more competitive price when compared to at least one other entry in the database results, and providing the database results, including the modified entry, to a customer. The computing device is further capable of providing the modified entry to a second database such that the second database also includes the modified entry. The computing device may be capable of replacing the at least one entry in the first database with the modified entry. The computing device may be capable of modifying the entry and providing the modified entry to the second database in real time.

In one embodiment, the computing device may be further capable of providing the modified entry to a plurality of second databases such that the plurality of second databases also includes the modified entry. The second database may be capable of providing the modified entry to a plurality of other databases such that the other databases include the modified entry. The second database may provide the modified entry to the plurality of other databases upon an approval of the modified entry by an administrator of the second database.

In addition to the system for synchronizing price information as described above, other aspects of the invention are directed to corresponding methods and computer program products for synchronizing price information.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for synchronizing price information, according to one embodiment of the invention;

FIG. 2 is a flowchart of the operation of synchronizing price information, according to one embodiment of the invention; and

FIGS. 3A and 3B are functional block diagrams illustrating a flow of price information in a system for synchronizing price information, according to two alternative embodiments of the invention.

### DETAILED DESCRIPTION OF THE INVENTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Although the concepts of embodiments of the invention are explained below in connection with travel products and services, they are obviously not limited to such products and services. The general approach should be extensible to almost anything that can be purchased via two or more sales channels, including but not limited to computer hardware and software, CD's, automobiles, insurance, mortgages, retail goods, and the like.

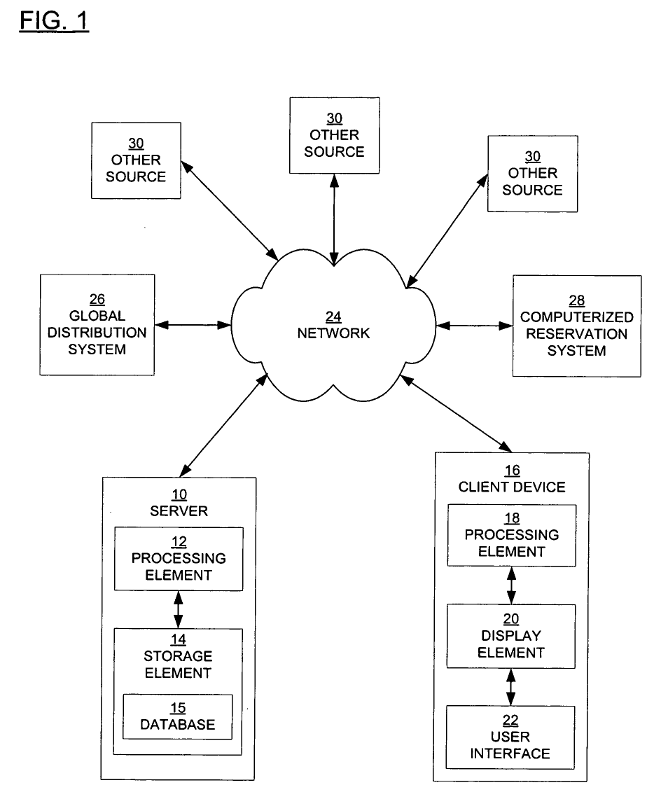

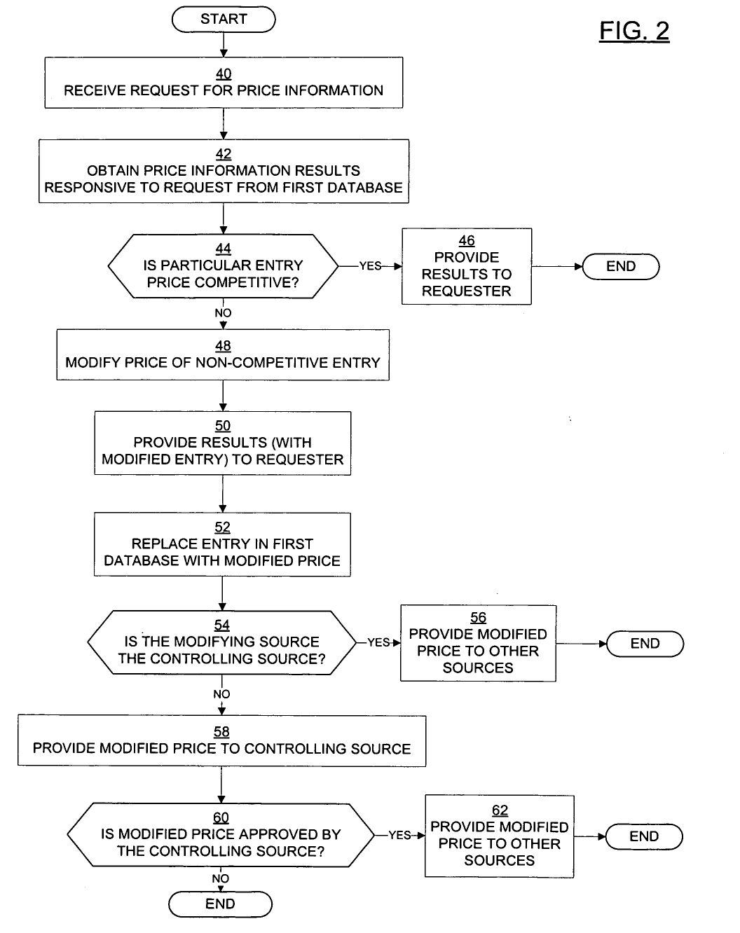

Referring to both FIG. 1 and FIG. 2, the process of synchronizing price information will be described, in accordance with one embodiment of the invention. FIG. 1 is a schematic block diagram of a system for synchronizing price information among various sources of price information, according to one embodiment of the invention. FIG. 1 illustrates a system using a client/server configuration. While FIG. 1 illustrates a system of one embodiment of the invention using a client/server configuration, it should be appreciated that the client/server configuration is shown for example purposes only and that the system of other embodiments of the invention could utilize configurations other than client/server. It should also be appreciated that the overall system architecture shown in FIG. 1 is for example purposes only, and not intended to limit the scope of the invention. Embodiments of the system of the invention could be implemented using a number of different system configurations and/or computing devices. FIG. 2 is a flowchart of the operation of synchronizing price information, according to one embodiment of the invention.

The system of FIG. 1 comprises a pair of computing devices, such as a server 10 and a client device 16, in communication over a network 24, such as the Internet. The server 10 comprises a processing element 12 and a storage element 14. The client device comprises a processing element 18, a display element 20, and a user interface 22. The client device 16 would typically be a personal computer, but may be any suitable device, including but not limited to telephones (including landline, mobile, web-enabled, etc.), laptop computers, mobile computers, pocket PCs, Blackberries™, and the like. The display element 20 may be, for example, a CRT or LCD, and the user interface may be, for example, a keyboard and/or a pointing device such as a mouse.

When a potential customer desires to determine the price of an item, such as a hotel reservation in a particular city, the customer may enter a request via client 16 using user interface 22. The format of such requests is known in the art, and such requests will typically include sufficient information to identify and obtain pricing for the desired item. However, the particular information included in any particular request may vary depending upon many factors such as the type of item for which price information is requested.

Processing element 18 may transmit the request to the server 10 over network 24, where the request may be received by processing element 12. See block 40 of FIG. 2. The server 10 may host, for example, a travel planning website which may be accessed by potential customers to determine the price and availability, and possibly to purchase, travel services. In response to the customer's request, the processing element 12 of server 10 may access price information responsive to the request. See block 42 of FIG. 2. The price information may be accessed from a database 15 stored in storage element 14. The database 15 will typically contain price (and availability) information for many different travel services from many different travel service suppliers. The price information that is contained in the database 15 may have originated from many different sources, such as one or more GDSs 26, from one or more CRSs 28, or from any suitable source of price information. For example, the price information for hotel reservations for a particular hotel chain may originate from the CRS of that hotel chain. The information contained in the database 15 may be obtained from the original source(s) and stored in the database on a periodic basis, such as once per day. In an alterative embodiment of the invention, the price information may be obtained by the server 10 as needed (i.e., in real time) in response to received requests, rather than being stored in the server. It should also be appreciated that the computing device which receives the price request (server 10 in this example) may, in another alternative embodiment, also be the original source of the price information. For example, server 10 could host the CRS for a hotel chain and could receive price requests from potential customers via the network 24.

The price information accessed from database 15 may contain the price for two or more items of the same or similar type. For example, where the customer request is a request for price information for hotel reservations, the price information will typically include the prices for several different hotels that correspond to the request. Typically based on an agreement with one of the service providers, and prior to providing the price information to the client device 16, the processing element 12 may compare the price of one of the items (i.e., the item supplied by the service provider that is a party to the agreement) to the price of the other items corresponding to the request. This comparison is typically to determine if the price of the one item is competitive relative to the price of the other items. See block 44 of FIG. 2. If the price is not competitive it may be because the price is under-competitive (i.e., too expensive relative to the other items, such that the customer is less likely to purchase this item) or over-competitive (too inexpensive relative to the other items, such that the item likely could be sold at a higher price to generate higher revenue).

The determination of competitiveness may be accomplished using many different methods. The processing element 12 may use, for example, a customer choice model (such as a logit discrete choice model or any other suitable model) to determine at what price the particular item is likely to sell with maximized revenue. The processing element 12 would typically calculate a likelihood (expressed as a percentage) of a customer purchasing the particular item at the price accessed from database 15, considering the price of the other items corresponding to the request. The processing element 12 may then calculate the expected revenue of the particular item by multiplying the price by the calculated likelihood of purchase. The processing element may then determine if the expected revenue can be increased by changing (increasing or decreasing) the price of the particular item. As such, the price may be considered competitive if the price is determined to generate the highest possible expected revenue, and may be considered non-competitive if a different price may generate higher expected revenue. As an example, the price of one night stay at a particular hotel may be $425, as accessed from database 15. Based on the price of other hotels, the processing element 12 may determine that there is a 2% likelihood of a customer purchasing (i.e., reserving) a room in that particular hotel. The expected revenue may then be calculated as $425×0.02=$8.50. The processing element 12 may then determine that a different price, such as $350, would increase the likelihood of purchase to 7% (this may be, for example, because the different price is closer to the price of other hotels). The price of $350 may result in an expected revenue of $24.50 (i.e., $350×0.07). Thus, the processing element may determine that $425 is an under-competitive price, and may decrease the price before displaying the price, as discussed below. As another example, the price of one night stay at a particular hotel may be $350, as accessed from database 15. Based on the price of other hotels, the processing element 12 may determine that there is a 10% likelihood of a customer purchasing (i.e., reserving) a room in that particular hotel. The expected revenue may then be calculated as $350×0.10=$35.00. The processing element 12 may then determine that a different price, such as $425, would decrease the likelihood of purchase to 9% but would increase the expected revenue to $38.25 (i.e., $425×0.09). Thus, the processing element may determine that $350 is an over-competitive price, and may increase the price before displaying the price, as discussed below.

If the processing element 12 determines that the price of the item is competitive relative to the other items, the processing element will then typically transmit the price information (without modification) to the client device 16, where the information may be displayed for the customer on the display element 20. See block 46 of FIG. 2. However, if the processing element 12 determines that the price of the item is not competitive relative to the other items, the processing element 12 will then typically modify the price of the item according to predefined rules established by the supplier of the item. See block 48 of FIG. 2. This price modification may be a price decrease or a price increase. The processing element 12 will then typically transmit the price information (including the modification) to the client device 16, where the information may be displayed for the customer on the display element 20. See block 50 of FIG. 2. Thus, the customer does not see the non-competitive price, and may therefore be more likely to purchase the item. The selection of an item by the customer and the processing of an order are known in the art and thus will not be described herein.

The modified price may be used only for the customer request for which the price was modified, or the modified price may be used for future customer requests sent to the server 10, depending on the predefined rules established by the supplier of the item. If the modified price is to be used for future customer requests sent to the server 10, then the processing element 12 would typically store the modified price in the database 15 so that the modified price is readily available to be provided in response to future requests. See block 52 of FIG. 2.

If the modified price is stored in the database 15 and used for future requests, then the server 10 may be providing a different price for that item in response to customer requests than what other sources of price information for the same item are providing. The other sources of price information that may have different price information may include GDSs 26, CRSs 28, and many other sources 30 (such as other travel service websites, or the service provider's own website). As discussed above, having different sources of price information providing different prices for the same item may be undesirable. As such, the modified price information may be provided to the other sources of price information to synchronize the price information in the sources, such that the different sources may provide the same price for the same item in response to customer requests. The server 10 (which may be termed a modifying source, as it is capable of modifying the price of an item) may send the modified price information directly to the other sources of price information, if authorized to do so by the supplier. If the server is authorized to send the modified price information directly to the other sources, the server 10 may also be termed a controlling source. As such, it would typically be determined if the server 10 (i.e., the modifying source) is authorized to send out the modified price information (i.e., is a controlling source). See block 54 of FIG. 2. If the modifying source is also a controlling source, then the modifying source may provide the modified price to the other sources. See block 56 of FIG. 1.

Alternatively, the server 10 may send the modified price information to a separate controlling source. See block 58 of FIG. 2. The controlling source function may be performed by the supplier itself or by some other entity authorized by the supplier to control the distribution of modified prices. The controlling source may determine, using predefined rules, whether to approve the distribution of the modified price to the other sources. See block 60 of FIG. 2. The approval may be done automatically or manually. If the modified price is approved by the controlling source, the controlling source may send the modified price to the other sources. See block 62 of FIG. 2.

The modified price may be transmitted (from the modifying source to the other sources, from the modifying source to the controlling source, or from the controlling source to the other sources) using any appropriate method and format for transmitting data. The modified price may be transmitted using an electronic format to enable the other sources to automatically incorporate the modified price into a price database at each source. For example, the modified price may be transmitted via a web service (a software system designed to support interoperable machine-to-machine interaction over a network), typically using a file in extensible markup language (XML) format. Other electronic formats that may be used include, but are not limited to, Electronic Data Interchange For Administration, Commerce, and Transport (EDIFACT), file transfer protocol (FTP), email, or Weblogic™. Alternatively, the modified price may be transmitted to the other sources using a method (e.g., facsimile) that may require the modified price to be manually input into a price database.

The analysis of the competitiveness of the price, the modification of the price, and the transmission of the modified price to the controlling source and/or the other sources typically is performed in real time (i.e., with little or no delay, except for the processing time and the transmission time).

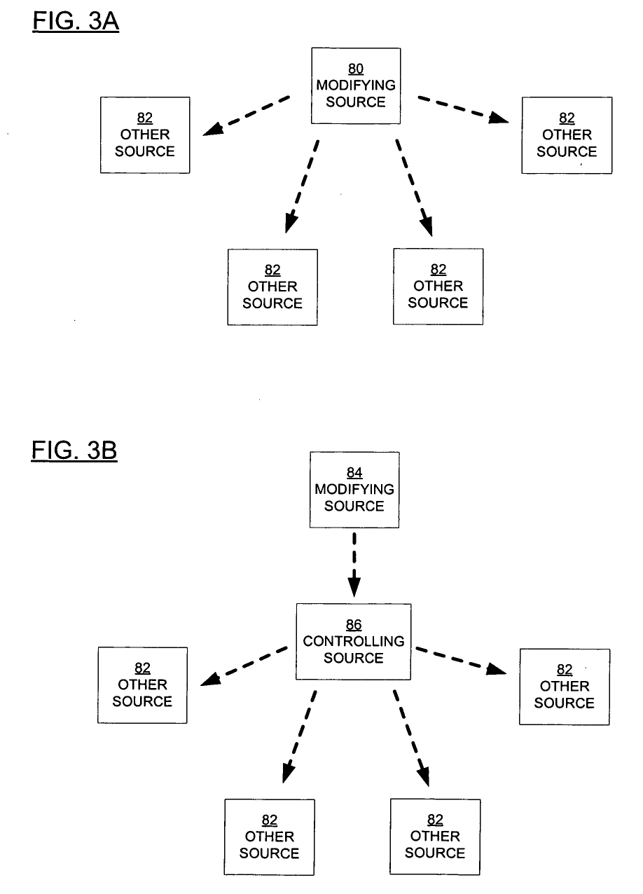

Referring now to FIGS. 3A and 3B, functional block diagrams of a flow of price information in a system for synchronizing price information are illustrated, according to two alternative embodiments of the invention. FIG. 3A illustrates an embodiment in which the modifying source 80 (e.g., server 10 of FIG. 1) is authorized by the supplier to send the modified price (illustrated by the dashed arrows) directly to the other sources 82 of price information. FIG. 3B illustrates an embodiment in which the modifying source 84 (e.g., server 10 of FIG. 1) is not authorized by the supplier to send the modified price directly to the other sources 82 of price information. As such, modifying source 84 typically sends the modified price to a controlling source 86, which may be the supplier as discussed above. In the embodiment of FIG. 3B, the controlling source 86 would typically determine if the modified price should be approved for transmission to the other sources in order to synchronize the price information in the sources. If approved, the controlling source may then transmit the modified price to the other sources, as illustrated in FIG. 3B.

In the embodiments of the invention described above, price information is synchronized such that the prices provided by all sources are identical. It should be appreciated that, in other embodiments of the invention, price information may be synchronized across different sources of price information such that all of the prices are not identical but rather such that a desired price differentiation is maintained between at least two different sources of price information. This desired differentiation may be predefined and may be expressed as a percentage or a dollar value. Even though the prices may be different across the channels, it may be desirable to transmit the current “state” of the competitive pricing in a different channel. As such, the supplier of travel services (or an intermediary seller of travel services) can modify prices accordingly in order to maintain a consistent price premium or price discount relative to one or more other channels. For example, a hotel website may have a business objective to position itself as the lowest priced channel of its products. The hotel website may predefine a price differentiation, such that the prices provided by the hotel website would be between $1 and $5 less than the corresponding prices provided by any of the GDSs, other travel intermediaries, and even the hotel's own phone-based reservation offices. Thus, the communication of the dynamically modified price from the modifying source to the hotel enables the hotel to correspondingly modify the price that is provided by the hotel website in order to maintain the desired price differentiation (i.e., to maintain the desired $1 to $5 discount relative to the modifying source).

According to one aspect of the invention, all or a portion of the system of one aspect of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In this regard, FIG. 2 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for synchronizing price information, the system comprising:
a computing device capable of receiving a request for price information associated with at least one item; the computing device further capable of obtaining database results from a first database responsive to the request, the database results comprising a plurality of entries each defining at least a price of the at least one item; the computing device further capable of modifying at least one entry in the database results by determining an expected revenue of the at least one item at both the price included in the database results and a more competitive price when compared to at least one other entry in the database results and changing the price to the more competitive price at least partially based on the expected revenue of the at least one item; the computing device further capable of providing the database results to a customer, the database results including the modified entry; and the computing device further capable of providing the modified entry to a second database such that the second database includes the modified entry.

2. The system of claim 1, wherein the computing device is further capable of modifying the at least one entry and providing the modified entry to the second database in real time.

3. The system of claim 1, wherein the computing device is further capable of providing the modified entry to a plurality of second databases such that the plurality of second databases include the modified entry.

4. The system of claim 1, wherein the computing device is further capable of replacing the at least one entry in the first database with the modified entry.

5. The system of claim 1, wherein the second database is capable of providing the modified entry to a plurality of other databases such that the other databases include the modified entry.

6. The system of claim 5, wherein the second database provides the modified entry to the plurality of other databases upon an approval of the modified entry by an administrator of the second database.

7. A method of synchronizing price information, the method comprising:
receiving a request for price information associated with at least one item;
obtaining database results from a first database responsive to the request, the database results comprising a plurality of entries each defining at least a price of the at least one item;
modifying at least one entry in the database results by determining an expected revenue of the at least one item at both the price included in the database results and a more competitive price when compared to at least one other entry in the database results and changing the price to the more competitive price at least partially based on the expected revenue of the at least one item;
providing the database results to a customer, the database results including the modified entry; and
providing the modified entry to a second database such that the second database includes the modified entry.

8. The method of claim 7, wherein the at least one entry is modified in real time and the modified entry is provided to the second database in real time.

9. The method of claim 7, further comprising:
replacing the at least one entry in the first database with the modified entry.

10. The method of claim 7, further comprising:
providing the modified entry to a plurality of second databases such that the plurality of second databases include the modified entry.

11. The method of claim 7, further comprising:
providing the modified entry from the second database to a plurality of other databases such that the other databases include the modified entry.

12. The method of claim 11, wherein the modified entry is provided to the plurality of other databases upon an approval of the modified entry by an administrator of the second database.

13. A computer program product for synchronizing price information, the computer program product comprising at least one computer-readable storage medium having computer-readable program code portions stored therein, the computer-readable program code portions comprising:
a first executable portion capable of receiving a request for price information associated with at least one item;
a second executable portion capable of obtaining database results from a first database responsive to the request, the database results comprising a plurality of entries each defining at least a price of the at least one item;
a third executable portion capable of modifying at least one entry in the database results by determining an expected revenue of the at least one item at both the price included in the database results and a more competitive price when compared to at least one other entry in the database results and changing the price to the more competitive price at least partially based on the expected revenue of the at least one item;
a fourth executable portion capable of providing the database results to a customer, the database results including the modified entry; and
a fifth executable portion capable of providing the modified entry to a second database such that the second database includes the modified entry.

14. The computer program product of claim 13, wherein the third executable portion modifies the at least one entry in real time and the sixth executable portion provides the modified entry to the second database in real time.

15. The computer program product of claim 13, further comprising:
a sixth executable portion capable of replacing the at least one entry in the first database with the modified entry.

16. The computer program product of claim 13, further comprising:
a sixth executable portion capable of providing the modified entry to a plurality of second databases such that the plurality of second databases include the modified entry.

17. The computer program product of claim 13, further comprising:
a seventh executable portion capable of providing the modified entry from the second database to a plurality of other databases such that the other databases include the modified entry.

18. The computer program product of claim 17, wherein the seventh executable portion provides the modified entry to the plurality of other databases upon an approval of the modified entry by an administrator of the second database.

19. The system of claim 1, wherein the computing device is further capable of determining the expected revenue of the at least one item based at least in part on a likelihood of selling the at least one item at the more competitive price.

20. The method of claim 7, wherein modifying comprises determining the expected revenue of the at least one item based at least in part on a likelihood of selling the at least one item at the more competitive price.

21. The computer program product of claim 13, wherein the third executable portion is configured to determine the expected revenue of the at least one item based at least in part on a likelihood of selling the at least one item at the more competitive price.
